(19) United States
(12) Patent Application Publication
(10) Pub. No.: US 2012/0092500 A1
(43) Pub. Date: Apr. 19, 2012

(54) IMAGE CAPTURE DEVICE AND METHOD FOR DETECTING PERSON USING THE SAME

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/970,960

(22) Filed: Dec. 17, 2010

(30) Foreign Application Priority Data
Oct. 19, 2010 (TW) 99135521

(51) Int. Cl. H04N 7/18

(52) U.S. Cl. 348/155; 348/E07.085

(57) ABSTRACT

A method for detecting a person using an image capture device obtains a plurality of images of a monitored scene captured by a lens module of the image capture device, and detects an area of motion in the monitored scene from the obtained images. The method further checks for a person in the area of motion, and adjusts the lens module of the image capture device according to movement data of the area of motion to focus the lens module on the person.

### BACKGROUND

1. Technical Field

Embodiments of the present disclosure relate to security surveillance technology, and particularly to an image capture device and method for detecting a person using the image capture device.

2. Description of Related Art

Image capture devices have been used to perform security surveillance by capturing images of monitored scenes, and sending the captured images to a monitor computer. The image capture device may detect the presence of a person by examining an entire image captured by the image capture devices using a person detection method. If the captured image is large (e.g., a high definition image), a lot of time is wasted checking all data of the image to detect the person. Therefore, an efficient method for detecting a person using the image capture device is desired.

### BRIEF DESCRIPTION OF THE DRAWINGS

FIG. 1 is a block diagram of one embodiment of an image capture device.

FIG. 2 is a block diagram of one embodiment of a person detection system.

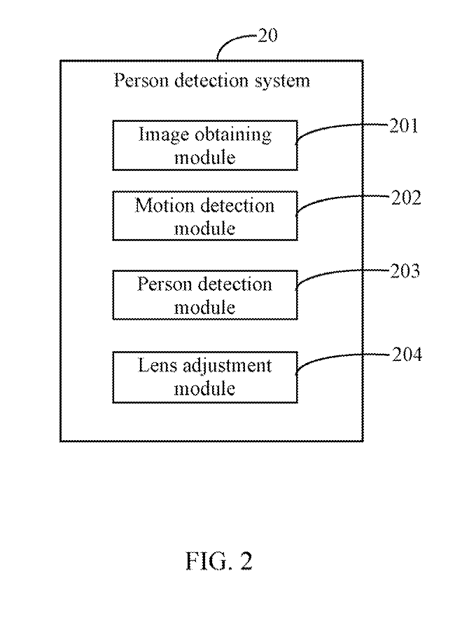

FIG. 3 is a flowchart of one embodiment of a method for detecting a person using the image capture device.

FIG. 4 is a schematic diagram of one embodiment of a motion area.

FIG. 5 is a schematic diagram of one embodiment of detecting a person in the motion area in FIG. 4.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

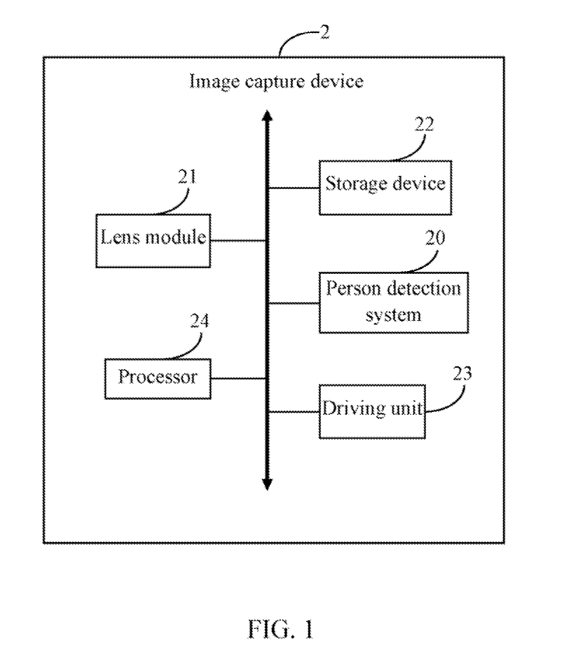

FIG. 1 is a block diagram of one embodiment of an image capture device 2. In one embodiment, the image capture device 2 includes a person detection system 20, a lens module 21, a storage device 22, a driving unit 23, and at least one processor 24. The person detection system 20 may be used to detect an area of motion in a monitored scene from images captured by the lens module 21, and further detect a person in the area of motion. A detailed description will be given in the following paragraphs.

In one embodiment, the image capture device 2 may be a speed dome camera or pan/tilt/zoom (PTZ) camera, for example. The monitored scene may be the interior of a warehouse or other important place.

The lens module 21 captures a plurality of images of the monitored scene. In one embodiment, the lens module 21 may include a charge coupled device (CCD) as well as lenses. The driving unit 23 may be used to aim, focus, and zoom the lens module 21 of the image capture device 2. In one embodiment, the driving unit 23 may be one or more driving motors.

In one embodiment, the person detection system 20 may include one or more modules, for example, an image obtaining module 201, a motion detection module 202, a person detection module 203, and a lens adjustment module 204. The one or more modules 201-204 may comprise computerized code in the form of one or more programs that are stored in the storage device 22 (or memory). The computerized code includes instructions that are executed by the at least one processor 24 to provide functions for the one or more modules 201-204.

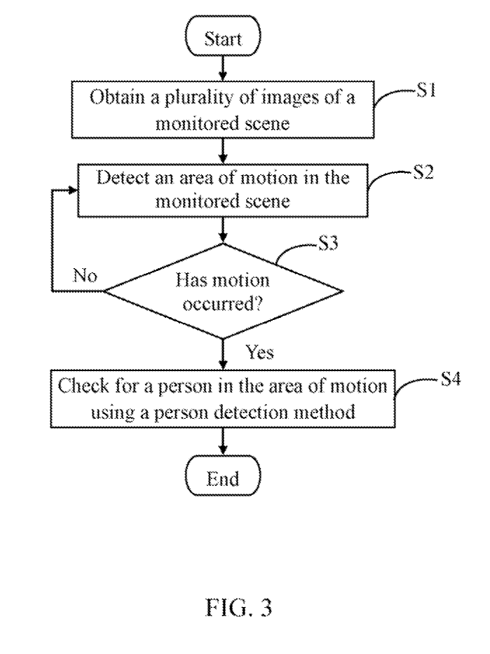

FIG. 3 is a flowchart of one embodiment of a method for detecting a person using the image capture device 2. Depending on the embodiment, additional blocks may be added, others removed, and the ordering of the blocks may be changed.

In block S1, the image obtaining module 201 obtains a plurality of images of a monitored scene captured using the lens module 21 of the image capture device 2. In one embodiment, the lens module 21 captures an images of the monitored scene after a preset time interval (e.g., five seconds).

In block S2, the motion detection module 202 detects an area of motion in the monitored scene from the obtained images. In one embodiment, the area of motion is regarded as an area of the monitored scene in which a moving object is detected. A detailed description is provided as follows.

First, the motion detection module 202 obtains a first image of the monitored scene at a first time from the obtained images, and calculates characteristic values (e.g., gray values of blue color) of the first image. Second, the motion detection module 202 obtains a second image of the monitored scene at a second time continuous with the first time, and calculates the characteristic values of the second image. Third, the motion area detection module 202 compares the first image with the second image using autocorrelation of the characteristic values of the first image and the second image, and obtains a corresponding area in both of the first image and the second image. Fourth, the motion detection module 202 compares the characteristic values of the corresponding area in both of the first image and the second image, and obtains an area of motion in the monitored scene if motion has occurred, according to differences in the characteristic values of the corresponding area in the first image and the second image.

In block S3, the motion detection module 202 determines if motion has occurred in the monitored scene. If motion is detected in the monitored scene, the procedure goes to block S4. If motion is not detected in the monitored scene, the procedure returns to block S2.

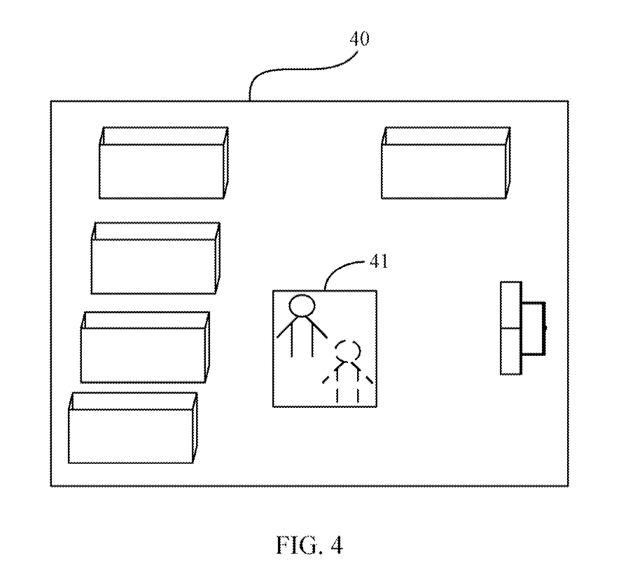

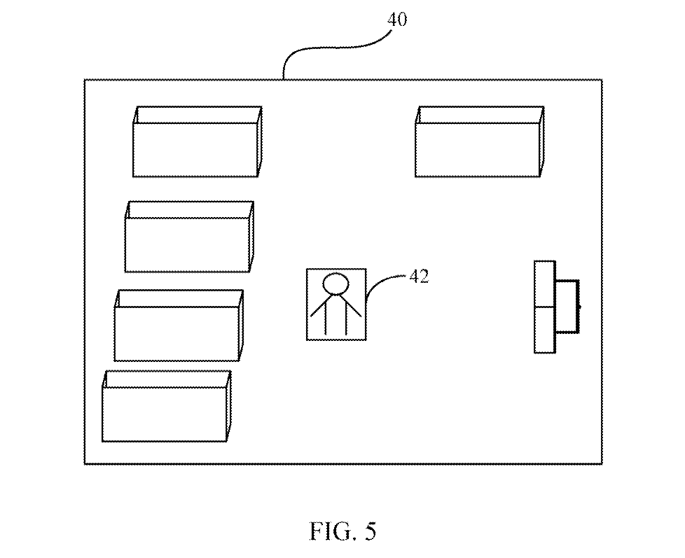

In block S4, the person detection module 203 checks for a person in the area of motion using a person detection method. In one embodiment, the person detection method may be a template matching method using neural network training algorithm and adaptive boosting (AdaBoost) algorithm. Referring to FIG. 4 and FIG. 5, an area of motion 41 is detected in a captured image 40 by the motion detection module 202 in FIG. 4, and a person 42 is further detected in the area of motion 41 by the person detection module 203 in FIG. 5.

In other embodiments, the lens adjustment module 204 adjusts the lens module 21 of the image capture device 2 according to movement data of the area of motion using the driving unit 23 to focus and zoom in on the lens module 21 on the person in the area of motion. In one embodiment, the movement data of the area of motion may include, but is not limited to, a direction of movement and a distance of movement. For example, the lens adjustment module 204 determines that the lens module 21 should move towards the left if the direction of movement in the area of motion is to the left, or determines that the lens module 21 should be moved towards the right if the direction of movement in the area of motion is to the right.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for detecting a person using an image capture device, the method comprising:
obtaining a plurality of images of a monitored scene, the images being captured using a lens module of the image capture device;
detecting an area of motion in the monitored scene from the obtained images; and
checking for a person in the area of motion using a person detection method.

2. The method according to claim 1, wherein the step of detecting an area of motion in the monitored scene from the obtained images comprises:
obtaining a first image of the monitored scene at a first time from the obtained images, and calculating characteristic values of the first image;
obtaining a second image of the monitored scene at a second time continuous with the first time, and calculating the characteristic values of the second image;
comparing the first image with the second image using autocorrelation of the characteristic values of the first image and the second image, and obtaining a corresponding area in both of the first image and the second image; and
comparing the characteristic values of the corresponding area in both of the first image and the second image, and obtaining an area of motion in the monitored scene, according to differences in the characteristic values of the corresponding area in the first image and the second image.

3. The method according to claim 1, wherein the person detection method is a template matching method using neural network training and adaptive boosting.

4. The method according to claim 1, further comprising: adjusting the lens module of the image capture device according to movement data of the area of motion to focus the lens module on the person in the area of motion.

5. The method according to claim 1, further comprising: zooming in the lens module of the image capture device.

6. An image capture device, comprising:
a lens module;
a storage device;
at least one processor; and
one or more modules that are stored in the storage device and are executed by the at least one processor, the one or more modules comprising instructions:
to obtain a plurality of images of a monitored scene, the images being captured using the lens module of the image capture device;
to detect an area of motion in the monitored scene from the obtained images; and
to check for a person in the area of motion using a person detection method.

7. The image capture device according to claim 6, wherein the instruction to detect an area of motion in the monitored scene from the obtained images comprises:
obtaining a first image of the monitored scene at a first time from the obtained images, and calculating characteristic values of the first image;
obtaining a second image of the monitored scene at a second time continuous with the first time, and calculating the characteristic values of the second image;
comparing the first image with the second image using autocorrelation of the characteristic values of the first image and the second image, and obtaining a corresponding area in both of the first image and the second image; and
comparing the characteristic values of the corresponding area in both of the first image and the second image, and obtaining an area of motion in the monitored scene, according to differences in the characteristic values of the corresponding area in the first image and the second image.

8. The image capture device according to claim 6, wherein the person detection method is a template matching method using neural network training and adaptive boosting.

9. The image capture device according to claim 6, wherein the one or more modules further comprise instructions: to adjust the lens module of the image capture device according to movement data of the area of motion to focus the lens module on the person in the area of motion.

10. The image capture device according to claim 6, wherein the one or more modules further comprise instructions: to zoom in the lens module of the image capture device.

11. A non-transitory storage medium having stored thereon instructions that, when executed by a processor of an image capture device, causes the processor to perform a method for detecting a person using the image capture device, the image capture device being installed in an orbital system, the method comprising:
obtaining a plurality of images of a monitored scene, the images being captured using a lens module of the image capture device;
detecting an area of motion in the monitored scene from the obtained images; and
checking for a person in the area of motion using a person detection method.

12. The non-transitory storage medium according to claim 11, wherein the step of detecting an area of motion in the monitored scene from the obtained images comprises:
obtaining a first image of the monitored scene at a first time from the obtained images, and calculating characteristic values of the first image;
obtaining a second image of the monitored scene at a second time continuous with the first time, and calculating the characteristic values of the second image;
comparing the first image with the second image using autocorrelation of the characteristic values of the first image and the second image, and obtaining a corresponding area in both of the first image and the second image; and
comparing the characteristic values of the corresponding area in both of the first image and the second image, and obtaining an area of motion in the monitored scene, according to differences in the characteristic values of the corresponding area in the first image and the second image.

13. The non-transitory storage medium according to claim 11, wherein the person detection method is a template matching method using neural network training and adaptive boosting.

14. The non-transitory storage medium according to claim 11, wherein the method further comprises: adjusting the lens module of the image capture device according to movement data of the area of motion to focus the lens module on the person in the area of motion.

15. The non-transitory storage medium according to claim 11, wherein the method further comprises: zooming in the lens module of the image capture device.

16. The non-transitory storage medium according to claim 11, wherein the medium is selected from the group consisting of a hard disk drive, a compact disc, a digital video disc, and a tape drive.
